(19) United States
(12) Patent Application Publication
(10) Pub. No.: US 2015/0004270 A1
(43) Pub. Date: Jan. 1, 2015

(54) FIXING DEVICE AND MOLD HAVING FIXING DEVICE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 14/050,373

(22) Filed: Oct. 10, 2013

(30) Foreign Application Priority Data
Jun. 28, 2013 (TW) 102123384

(51) Int. Cl. B29D 11/00

(52) U.S. Cl. CPC B29D 11/0075
USPC 425/123

(57) ABSTRACT

A fixing device for fixing cores includes a base and a cover. The base defines holding grooves. Each holding groove includes a V-shaped portion and a through hole connected with the V-shaped portion. The cover is fixed on the base to secure the cores inside the holding grooves.

### BACKGROUND

1. Technical Field

The present disclosure relates to fixing devices and, particularly, to a fixing device for fixing cores and a mold having the fixing device.

2. Description of Related Art

Optical communication devices include circuit board, lenses, jumpers and optical fibers, for example. The jumper is used to couple the optical fibers and the lenses. The jumper defines optical fiber holes for holding the optical fibers. The optical fiber holes can be blind holes or through holes, generally through holes.

Jumpers are made by injection molding machines. The injection molding machine may include fixing device for fixing cores and the cores are configured for forming the optical fiber holes. The fixing device is a slide block and the slide block defines through holes to fix the cores. However, it is difficult to manufacture the through holes on the slide block.

Therefore, it is desirable to provide a fixing device and a mold having the fixing device, which can overcome the limitation described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of a fixing device for fixing cores, according to an exemplary embodiment of the present disclosure.

FIG. 2 is an explosive view of FIG. 1.

FIG. 3 is a cross-sectional view taken along line III-III of FIG. 2.

FIG. 4 is a cross-sectional view taken along line IV-IV of FIG. 1.

### DETAILED DESCRIPTION

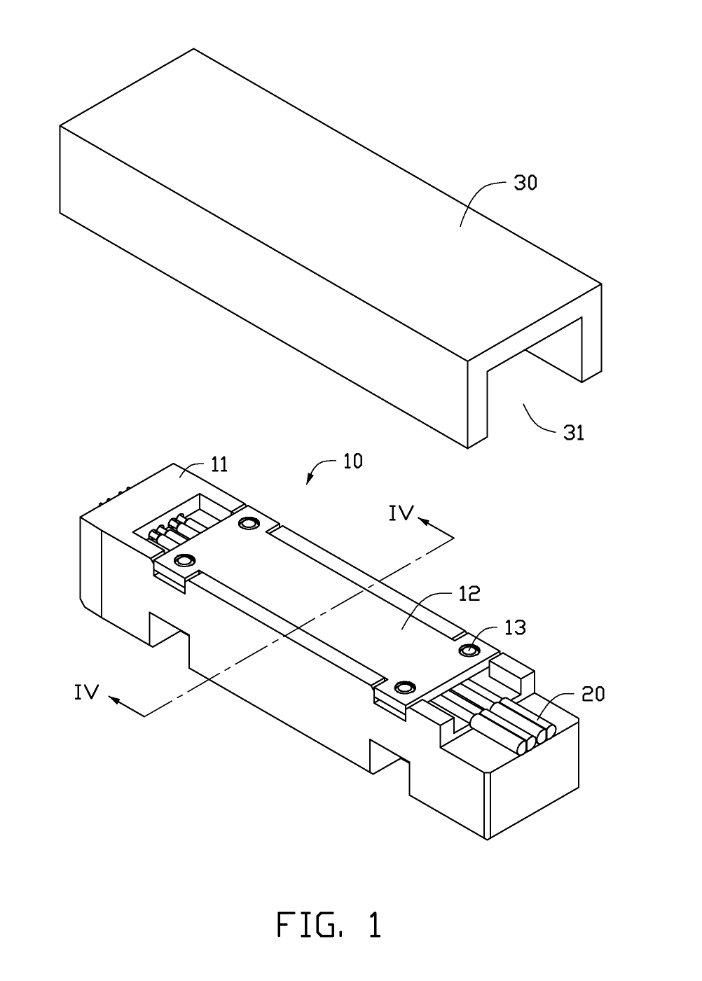

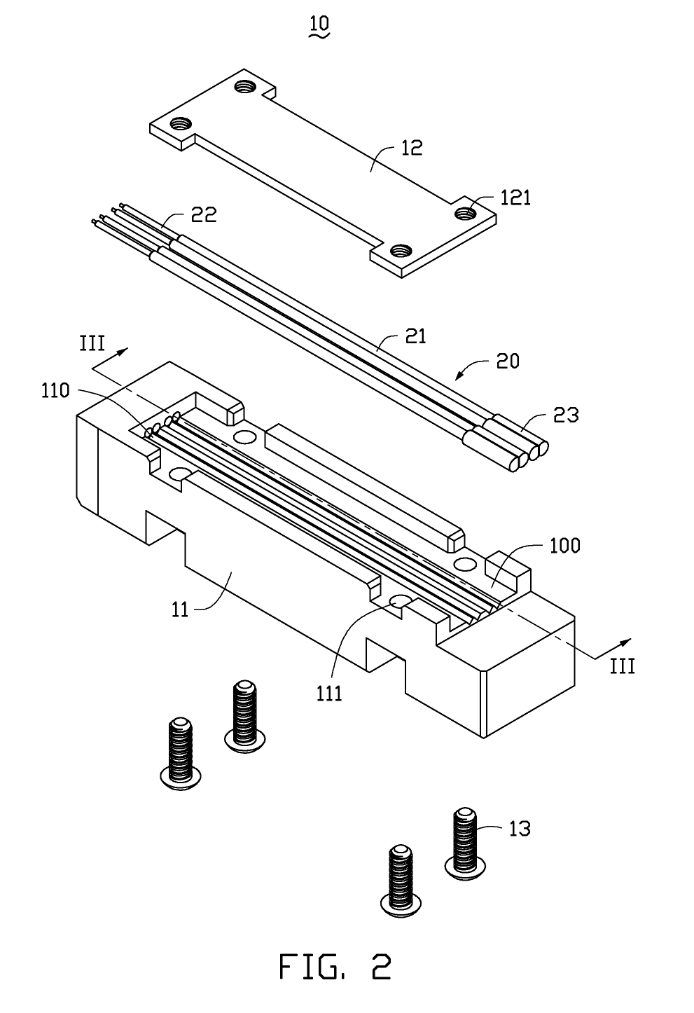

FIG. 1 and FIG. 2 show a fixing device 10 for fixing cores 20 according to an exemplary embodiment. The fixing device 10 is set in a mold 30. The mold 30 includes a chamber 31 for holding the fixing device 10. The mold 30 is used to manufacture jumpers and the cores 20 are used to form optical fiber holes of the jumpers. The mold 30 is a part of actual injection molding machine described in the related art.

The material of the cores 20 can be tungsten steel. Each core 20 includes a bigger portion 21, a smaller portion 22, and an ending portion 23 being coaxial with the bigger portion 21 and the smaller portion 22. The bigger portion 21 is connected between the smaller portion 22 and the ending portion 23. Diameter of the bigger portion 21 is larger than diameter of the smaller portion 22 and smaller than diameter of the ending portion 23.

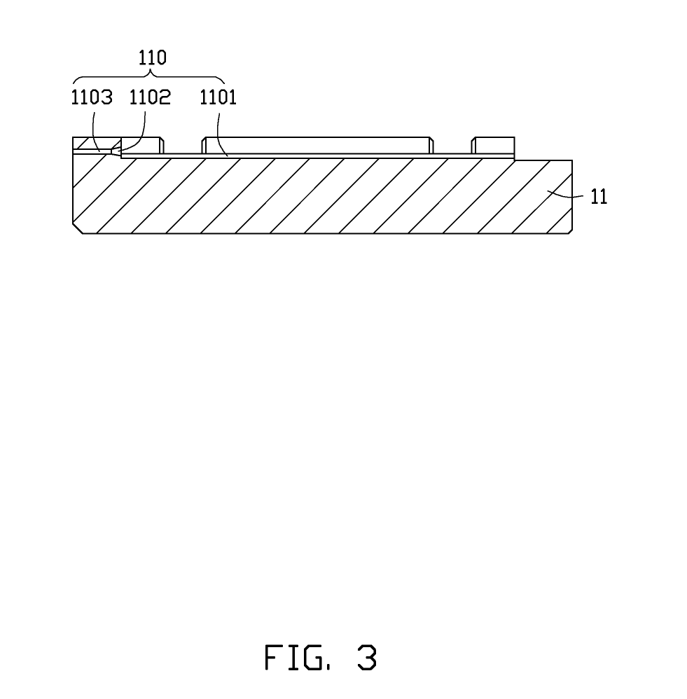

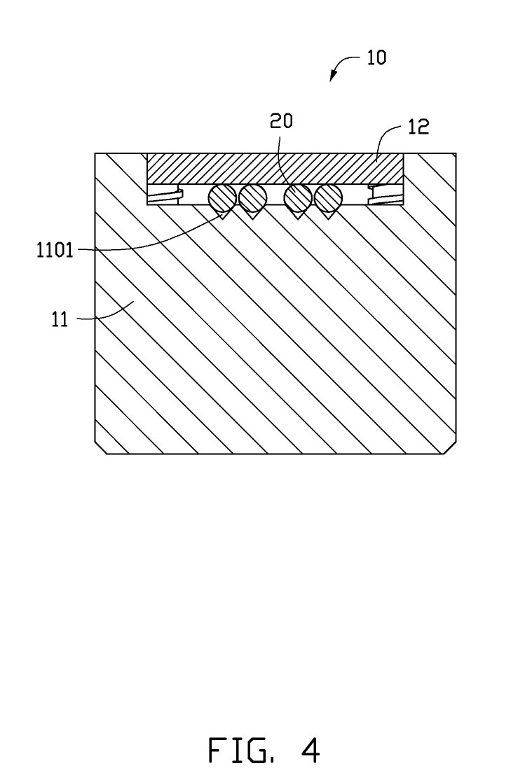

FIG. 3 and FIG. 4 show that the fixing device 10 includes a base 11, a cover 12, and four screws 13. The cover 12 is fixed on the base 11 by the screws 13.

The base 11 has a rectangle shape. The base 11 defines a recess 100 and four first screw holes 111. Two of the screw holes 111 are arranged at one side of the recess 100, and the other two of the screw holes 111 are arranged at another side of the recess 100. A plurality of holding grooves 110 is defined in a bottom of the recess 100. The holding grooves 110 are parallel to each other. Each holding groove 110 is configured for holding one core 20.

Each holding groove 110 includes a V-shaped portion 1101, a taper portion 1102, and a circular portion 1103. The circular portion 1103 is coaxial with the V-shaped portion 1101 and the taper portion 1102. The taper portion 1102 is connected between the V-shaped portion 1101 and the circular portion 1103. The circular portion 1103 is a through hole. The circular portion 1103 and the taper portion 1102 can at least hold a part of smaller portion 22. Total length labeled h1 of the taper portion 1102 and the circular portion 1103 is less than length labeled h2 of the V-shaped portion 1101. In this embodiment, the value of h1 is a quarter of the value of h2.

The V-shaped portions 1101 are more easily manufactured than the taper portion 1102 and the circular portion 1103. So the holding grooves 110 having the V-shaped portions 1101 are easily manufactured.

In other embodiments, the taper portion 1102 is omitted and the V-shaped portion 1101 is directly connected with the circular portion 1103. The length of the V-shaped 1101 is smaller than the length of the circular portion 1103.

The diameter of the taper portion 1102 reduces from the V-shaped portion 1101 toward the circular portion 1103, thus, the V-shaped portion 1101 can guide the smaller portion 22 of the core 20 into the circular portion 1103. The smaller portion 22 is inserted into the circular portion 1103 and is partially exposed out of the base 11. The bigger portion 21 is set in the V-shaped portion 1101, and the ending portion 23 contacts the base 11.

Length of the cover 12 is smaller or equal to that of the recess 100, and width of the cover 12 is larger than width of the recess 100. Four second screw holes 121 are defined on the cover 12 corresponding to the first screw holes 111. The screws 13 pass through the first screw holes 111 from bottom surface of the base 11 and insert into the second screw holes 121, thus, the cover 12 is fixed on the base 11. The cores 20 are received in the holding grooves 110 by the base 11 together with the cover 12.

Each holding groove 11 includes the V-shaped portion 1101, the taper portion 1102, and the circular portion 1103, but is not a complete through hole. The total length of the taper portion 1102 and the circular portion 1103 is less than that of the V-shaped portion 1101, so the holding groove 11 is easily manufactured.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A fixing device for fixing cores, comprising:
a base defining holding grooves for holding the cores, each holding groove comprising a V-shaped portion and a through hole connected with the V-shaped portion, the V-shaped portion being coaxial with the through hole, a length of the through hole being smaller than a length of the V-shaped portion; and
a cover fixing on the base to secure the cores inside the holding grooves.

2. The fixing device of claim 1, wherein each through hole comprises a circular portion and a taper portion between the V-shaped grove and the circular portion, and a diameter of the taper portion reduces from the V-shaped portion toward the circular portion.

3. The fixing device of claim 1, comprising screws, the cover fixed on the base by the screws.

4. The fixing device of claim 3, wherein the base defines first screw holes, the cover defines second screw holes, and the screws are screwed in the first screw holes and the second screw holes.

5. The fixing device of claim 1, wherein the material of the cores is tungsten steel.

6. A mold for manufacturing jumper, the jumper comprising holes for holding optical fibers, the mold comprising:
cores configured for forming the holes; and
a fixing device for fixing the cores, the device comprising:
a base defining holding grooves holding the cores, each holding groove comprising a V-shaped portion and a through hole connected with the V-shaped portion, the V-shaped portion being coaxial with the through hole, a length of the through hole being smaller than a length of the V-shaped portion; and
a cover fixed on the base to secure the cores inside the holding grooves.

7. The mold of claim 6, wherein each through hole comprises a circular portion and a taper portion between the V-shaped grove and the circular portion, and a diameter of the taper portion reduces from the V-shaped portion toward the circular portion.

8. The mold of claim 6, comprising screws, the cover fixed on the base by the screws.

9. The mold of claim 8, wherein the base defines first screw holes, the cover defines second screw holes, and the screws are screwed in the first screw holes and the second screw holes.

10. The mold of claim 6, wherein the material of the cores is tungsten steel.

11. The mold of claim 6, wherein the mold defines a chamber for holding the fixing device.
